(19) United States
(12) Patent Application Publication
(10) Pub. No.: US 2008/0283137 A1
(43) Pub. Date: Nov. 20, 2008

(54) Safety line hose

(76) Inventors: Willie M. Davis, JR., Springfield, OR (US); Geneva M. Franks, Eugene, OR (US); Scotty R. Randall, Eugene, OR (US)

Correspondence Address: GRAYBEAL, JACKSON, HALEY LLP, 155 - 108TH AVENUE NE, SUITE 350, BELLEVUE, WA, 98004-5973, US

(21) Appl. No.: 12/152,268

(22) Filed: May 12, 2008

Related U.S. Application Data
(63) Continuation-in-part of application No. 11/801,783, filed on May 11, 2007.

(51) Int. Cl. F16L 11/00

(52) U.S. Cl. 138/103; 29/428; 138/107; 138/109; 138/123

(57) ABSTRACT

A safety line hose to which a worker can be attached and which includes a passageway for communicating an air compressor with a pneumatic tool. The safety line hose can include an elongated flexible pneumatic hose, an elongated flexible tubing enveloping the pneumatic hose, and an elongated, flexible, wear resistant sheath enveloping the tubing. A compressor air hose connector or other suitable attachment is attached to the end of the pneumatic hose located at the first end of the safety line hose, and can be adapted to be connected to the outlet of an air compressor hose or other source of air such as the air compressor itself. A pneumatic tool connector can be attached to the end of the pneumatic hose located adjacent the second end of the safety line hose, and can be adapted to be connected to a pneumatic tool. A fastening member can be attached to the first end of the safety line hose and can be adapted to be releasably fastened to a safety line attachment member.

### CROSS-REFERENCE TO RELATED APPLICATIONS

The present application claims priority from and is a continuation-in-part application of U.S. patent application Ser. No. 11/801,783, filed May 11, 2007, presently pending.

### BACKGROUND

This relates to a safety line hose for use by workers requiring a safety line and whose job requires the use of pneumatic tools or other air-driven devices.

Workers such as roofers work at heights where a fall could cause serious injury or death. Occupational safety rules often require that such workers wear safety belts or harnesses which are attached to a safety line. The safety line can be secured to a member attached to the roof, such as the attachment member described in U.S. Pat. No. 4,249,713 (incorporated herein by reference in its entirety).

Roofers typically use a pneumatic nail or staple gun to secure roofing material to the structure. The use of a pneumatic gun requires the use of a pneumatic air hose extending from a compressor on the ground to the gun. The presence of both a safety line and a pneumatic air hose can lead to entanglement. If the pneumatic gun is dropped it can slide off the roof onto the ground.

### SUMMARY

The systems, devices, methods, etc., herein are directed to a safety line hose and methods of making and using the same. A worker can be attached to the safety line hose to reduce the likelihood the worker may suffer injury. The safety line hose includes a passageway for communicating compressed air with a pneumatic tool.

The safety line hose has at least first and second ends, and includes an elongated flexible pneumatic hose, and an elongated, flexile, wear resistant sheath enveloping the tubing. The hose can also include an elongated flexible tubing enveloping the pneumatic hose.

A compressor air hose connector or other suitable connector can be attached to the end of the pneumatic hose located at the first end of the safety line hose, and can be adapted to be connected to an air hose from an air compressor or other air source.

A fastening member can be attached to the first end of the safety line hose and can be adapted to be readably fastened to a safety line attachment member that securely attaches the safety line hose to a desired structure such as a roof of a house or a building under construction.

A pneumatic tool connector can be attached to the end of the pneumatic hose located adjacent the second end of the safety line hose, and can be adapted to be connected to a pneumatic tool.

These and other aspects, features and embodiments are set forth within this application, including the following Detailed Description and attached drawings. Unless expressly stated otherwise or clear from the context, all embodiments, aspects, features, etc., can be mixed and matched, combined and permuted in any desired manner.

### BRIEF DESCRIPTION OF THE DRAWINGS

FIGS. 1 and 1A are perspective views of a structure having a roof upon which the safety line hose is being used;

FIG. 2 is an enlarged perspective view of the upper end of a first embodiment of the safety line hose;

FIG. 3 is a cross-sectional view of the safety line hose; and

FIG. 4 is an enlarged perspective view of the upper end of a second embodiment of the safety line hose.

FIG. 4A is an enlarged perspective view of the upper end of a further embodiment of the safety line hose.

FIG. 5 is a plan view of a further embodiment of a safety line suitable for use in a safety line hose as discussed herein.

FIG. 6 is a plan view of a further embodiment of a safety line suitable for use in a safety line hose as discussed herein.

FIG. 7 is a plan view of a further embodiment of a safety line suitable for use in a safety line hose as discussed herein.

### DETAILED DESCRIPTION

The systems, devices, methods, etc., herein are directed to the combination of a pneumatic hose with a safety line for construction workers and the like to give a single elongated entity that is a pneumatic safety hose line (of course, if desired, multiple safety hose line lines can also be made or used, provided that each has both the pneumatic hose component and the safety line component). The pneumatic hose carries industrial quantities of compressed air from an air source (the air source can also or instead provide other gases, or even liquid to provide a hydraulic safety line hose, if desired) such as an air compressor or an output port or line from an air compressor or pressurized air tank, to a desired end point, typically a pneumatically driven tool such as a pneumatic hammer or drill. The safety line and pneumatic hose must be adequately co-extensive to provide a single elongated entity that provides both a safety line and a pneumatic air source to a worker, and are typically substantially co-extensive, although if desired the lines can be less than fully co-extensive. The safety line typically envelops the pneumatic hose, although if desired the line and hose can be braided or parallel or otherwise combined to give the single elongated entity.

Turning to a general discussion of the devices, systems, kits, methods, etc., herein, in one aspect there is provided a pneumatic safety line hose strong enough to substantially equal or exceed strength properties for roofer safety lines in OSHA occupational safety laws, the hose comprising: an elongated flexible pneumatic hose comprising at least first and second ends and a passageway from the first end to second end for communicating compressed air adequate to drive a pneumatic tool; and, an elongated flexible, safety line combined with and co-extensive with at least a substantial portion of the pneumatic hose to provide a single elongated entity forming the pneumatic safety line hose, the safety line hose configured to hold a worker to a structure. As with other components discussed herein, the elongated flexible pneumatic hose can be made of any suitable material(s) such as plastic or rubber, cloth, etc., while the elongated, flexible safety line can be made of any suitable material(s) such as nylon, hemp, metals, other plastics, rubber, cotton, etc.

In some embodiments, the first end of the elongated flexible pneumatic hose can comprise a first adaptor such as an air hose connector configured to operably connect to a source of compressed air and the second end can comprise a second adaptor such as a pneumatic tool connector configured to operably connect to the pneumatic tool. The first adaptor can be configured to connect to an air hose carrying air from an air compressor and the second adaptor can be configured to connect directly to the pneumatic tool. The safety line hose can comprise a safety fastening structure adapted to be releasably fastened to a safety line attachment member. The safety fastening structure can be a ring, for example in the shape of a circle, an oval, a D-shape, etc. A releasable fastening member such as a carabiner or snap hook can be attached to the safety line, the releasable fastening member adapted to releasably attach to the safety line attachment member. The safety line attachment member is typically releasably attached to a structure of interest but can be permanently attached if desired.

The safety line hose can comprise a sheath, typically wear resistant, with frictional properties adapted to allow a rope grab such as a sliding hitch knot, also known as a Prusik knot, or a mechanical rope grab, to cinch and hold, and if desired cinch-hold-release (repeat as desired). The elongated safety line can substantially envelop the elongated pneumatic hose where the hose and line are co-extensive. The line and hose can also be twin axial, intertwined, or otherwise combined as desired. The first end can comprise a compressor air hose connector that forms a part of a safety fastening structure, or that exits from the safety line hose prior to or after the safety fastening member. The safety line hose can comprise two rope grabs; if desired at least one of the rope grabs can function as the safety fastening structure.

The safety line hose can comprise or be attached to a retraction device such as a coiling device configured to extend the safety line hose in response to pulling and retract it when the pulling ceases. The safety line hose can also be provided in or used in systems or kits, for example with retraction devices, instructions, other safety equipment, pneumatic tools, air compressors, etc.

In another aspect, the current discussion is directed to methods of securing a worker to a structure comprising: anchoring to the structure a safety line hose as discussed herein; and, attaching the worker to the safety line hose.

In some embodiments, the methods can comprise delivering compressed air or other desired substance through the safety line hose to a pneumatic tool or other desired end device, driving the pneumatic tool using the compressed air, and/or providing a retraction device then extending the safety line hose from the retraction device in response to pulling and retracting it when the pulling ceases.

In a further aspect, the current discussion is directed to methods of making a safety line hose comprising: combining into a single elongated entity an elongated flexible pneumatic hose comprising first and second ends and a passageway for communicating compressed air (or other desired substance) adequate to drive a pneumatic tool (or use with other desired device) from the first end to the second end, and an elongated flexible, safety line to provide the pneumatic safety line hose configured to hold a worker to a structure.

In some embodiments, the methods can further comprise delivering compressed air through the safety line hose to a pneumatic tool, combining a hose and line strong enough to substantially equal or exceed strength properties for roofer safety lines in OSHA occupational safety laws. The methods further can comprise configuring the first end of the elongated flexible pneumatic hose to have a first adaptor configured to operably connect to a source of compressed air and configuring the second end to comprise a second adaptor configured to operably connect to the pneumatic tool. The first adaptor can be configured to connect to an air hose carrying air from an air compressor and the second adaptor can be configured to connect directly to the pneumatic tool. The methods can comprise providing a safety fastening structure in the safety line hose, the safety fastening structure adapted to be operably fastened to a safety line attachment member; attaching a releasable fastening member to the safety line, the releasable fastening member adapted to releasably attach to the safety line attachment member; configuring the safety line hose to operably accept a rope grab suitable to attach a worker to the safety line hose; and/or substantially enveloping the elongated pneumatic hose where the hose and line can be co-extensive.

The methods also can comprise attaching two rope grabs to the safety line hose; at least one of the rope grabs can be the safety fastening structure. The methods can comprise providing a retraction device configured to extend the safety line hose in response to pulling and retract it when the pulling ceases.

Turning to the exemplary embodiments shown in the Figures, starting with FIG. 3, the safety line hose 10 includes an inner flexible pneumatic hose 12 surrounded by a flexible tubing 14, such as nylon.

Flexible tubing 14 can be surrounded by a wear resistant sheath 16, such as braided nylon. The outer surface of wear resistant sheath 16 may have frictional properties that allow a sliding hitch knot such as a Prusik knot to cinch and hold.

Pneumatic hose 12 can be a conventional pneumatic hose and has strength properties that are equal to or exceed strength properties imposed upon pneumatic hose used for pneumatic tools by occupational safety laws, such as OSHA.

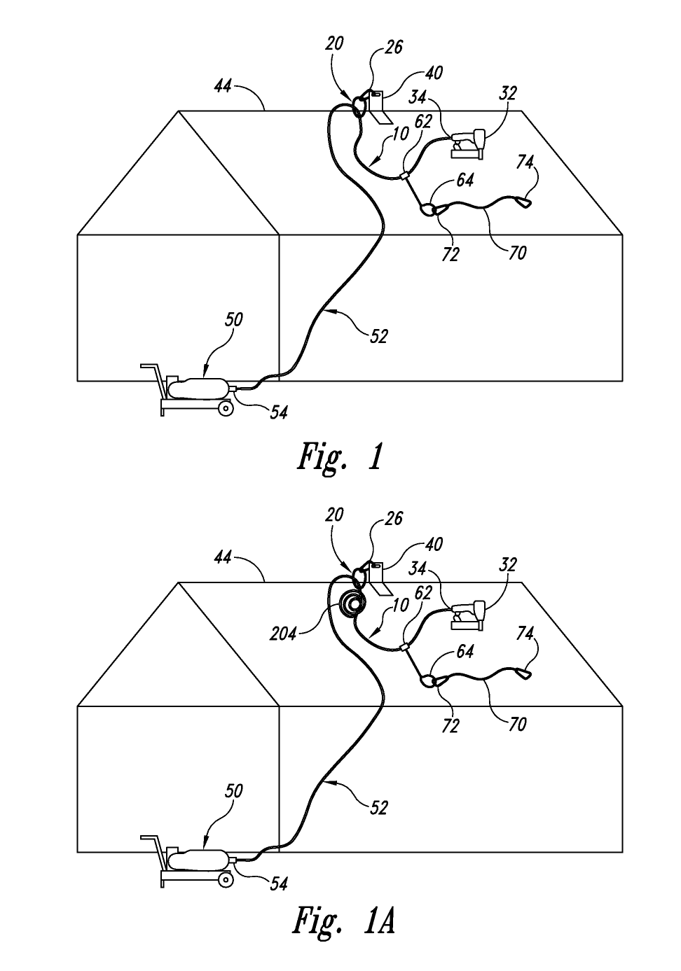

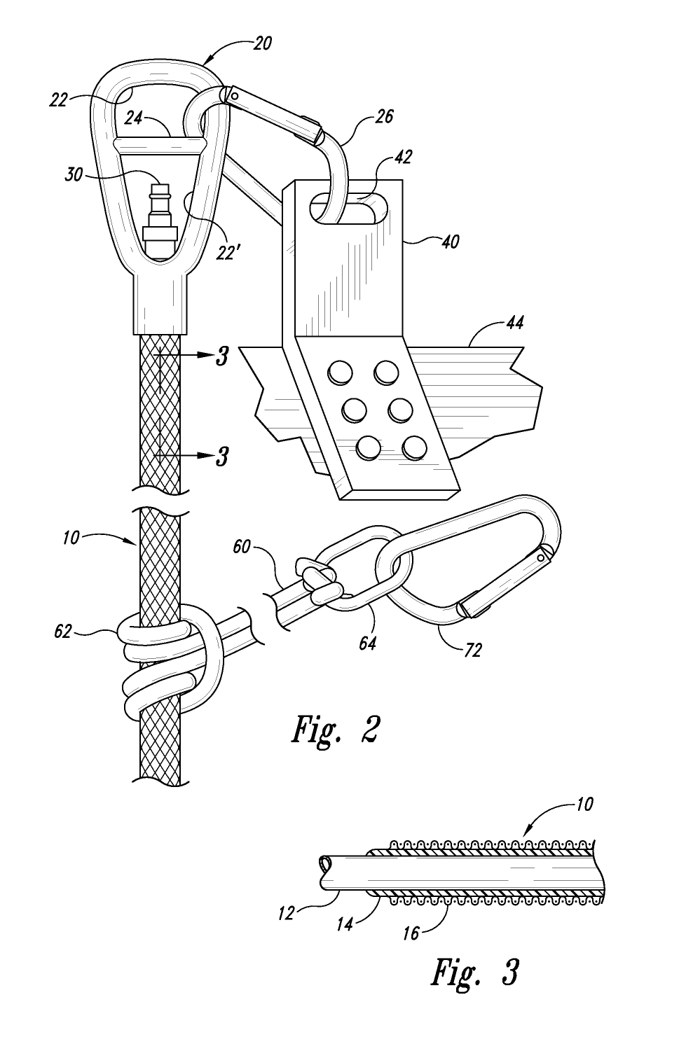

Turning to FIGS. 1-2, the first upper end of safety line hose 10 comprises a fastening structure such as ring structure 20 having openings 22, 22′. Ring structure 20 can be separated by a strengthening cross member 24. Other configurations of ring structures such as eye-splices can also be used. In FIG. 1A, an embodiment is shown wherein the first end of the safety line hose 10 is partially coiled in a retraction device 204 which in the embodiment shown is a spring-loaded retraction reel able extend the safety line hose in response to pulling and retract it when the pulling ceases.

The end of pneumatic hose 12 adjacent the first, upper end of safety line hose 10 has pneumatic connector 30 attached thereto to allow pneumatic hose 12 to be connected to an air hose 52 attached to an air compressor 50 via connector 54. Connector 30 and connector air hose 52 are of the type commonly used in the pneumatic tool art. In a first embodiment, pneumatic connector 30 is located within opening 22′ of ring structure 20.

As can be seen for example in FIG. 2, safety line hose 10 is attached by a carabiner 26, or other releasable fastening member, to attachment member 40 or other anchor that holds the safety line hose to the roof or other suitable structure. In the embodiment shown, carabiner 26 passes through opening 22 in ring structure 20 and through opening 42 in roof attachment member 40. Roof attachment member 40 is removably attached to roof 44 by nails, bolts or screws or other desired method. Alternatively, ring structure 20 can itself have a carabiner-type snap fastener construction that allows ring structure 20 to be directly attached to roof attachment member 40.

The lower end of pneumatic air hose 52 has a pneumatic connector 54 to allow pneumatic air hose 52 to be connected to a compressor 50 in a well-known manner.

The end of pneumatic hose 12 located adjacent the other end of the safety line hose 10 has pneumatic connector 34 to allow connection to pneumatic tool 32. Pneumatic connector 34 may be of well-known types.

As can be seen in the embodiment in FIG. 2, a Prusik cord 60 is formed into a Prusik knot 62 about safety line hose 10 to provide a rope grab. A sliding hitch knot such as a Prusik knot is a friction knot formed from a cord which can slide along a rope when no weight is applied, but which grips the rope when a pull is applied, such as that caused by a falling worker to whom the cord is attached. Generally, a sliding hitch knot can have double, triple, or quadruple wraps around the primary line. The outer end of the cord 60 is attached to a loop member 64. A safety cord 70 has releasable fastening member 72 and 74 attached at the inner and outer ends thereof, respectively, as best seen in FIG. 1. Releasable fastening members 72 and 74 can be carabiners. Releasable fastening member 72 is attached to loop 64 of Prusik cord 60, and releasable fastening member 74 is attached to safety harness or belt attached to a worker, not shown, in a well-known manner.

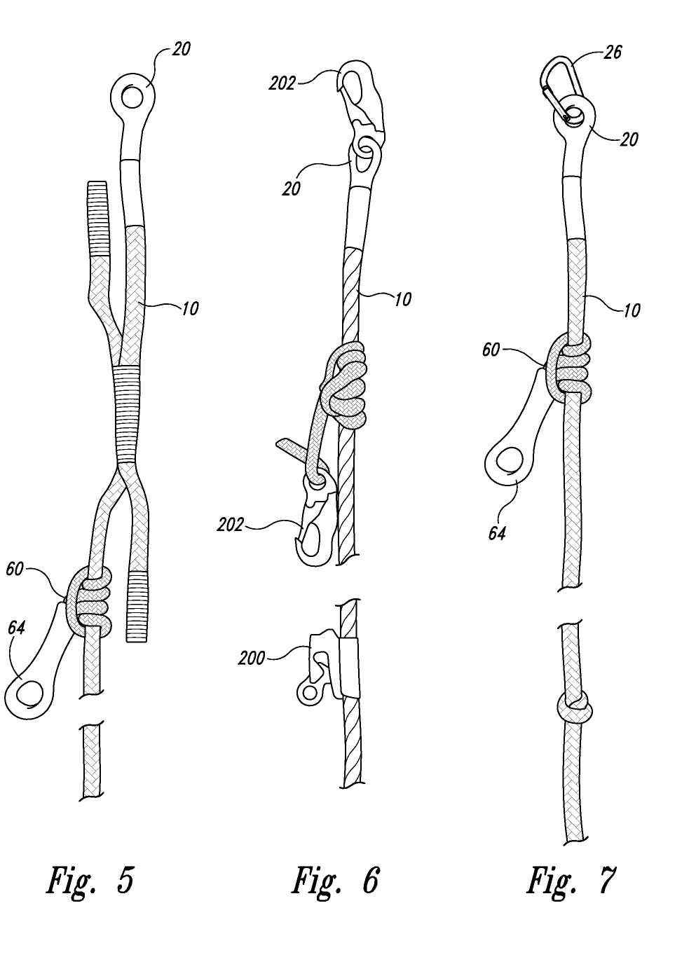

Other exemplary embodiments of safety lines suitable for use herein are shown in FIGS. 5-7 (in these Figures, the pneumatic hose component of the safety line hose 10 is not shown). Further, the tether between the safety line hose 10 and the roof attachment member 40 can be or comprise any of a variety of other rope grabs such as other sliding hitch knots, mechanical connectors, etc., or other safety devices. For example, as in FIG. 6, the releasable fastening member can also be a mechanical gripper 200 and ring structure 20 can be or be attached to a snap hook 202.

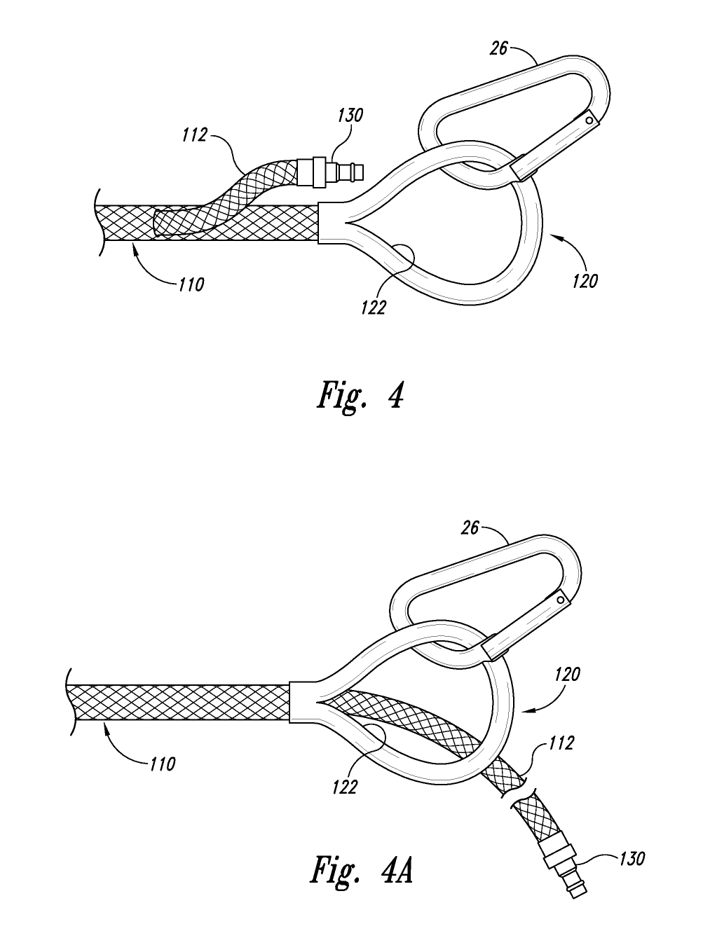

The upper pneumatic hose attachment fixture 30 of safety line hose 10, which is attached to pneumatic hose 12, is shown as forming a part of ring structure 20 of safety line hose 10 in the first embodiment illustrated in FIGS. 1 and 2. Alternatively, the upper end of pneumatic hose 112 can exit the first end of safety line hose 110 prior to or after ring structure 120, as shown in the second and third embodiments illustrated in FIGS. 4 and 4A. In the second embodiment, the upper end of the pneumatic hose 112 has an upper attachment fixture 130 which can be connected to pneumatic air hose 52. Ring structure 120 is attached to the upper end of safety line hose 110 and has an opening 122 therein to which carabiner 26 or other releasable fastening member can be attached and be used to fasten to roof attachment member 40 such as shown in the manner shown in FIG. 1. Alternatively, ring structure 120 can have a carabiner-type snap fastener construction that allows ring structure 120 to be directly attached to roof attachment member 40. In these embodiments, the structure of safety line hose 110 can be otherwise identical to that of safety line hose 10 shown in FIG. 3 with like parts having the same reference members but increased by 100. Similarly to the first ends of the pneumatic hose component and the safety line component of the safety line hose, shown in FIGS. 4 and 4A, the second ends of the pneumatic hose component and the safety line component may but need not end at exactly the same location.

The strength properties of safety line hose 10 are selected to equal to or exceed those strength properties imposed upon roofer safety line by occupational safety laws, such as OSHA, and typically strong enough to safely bear the weight of a falling human being.

The scope of the present devices, systems and methods, etc., includes both means plus function and step plus function concepts. However, the elements of the claims are not to be interpreted as indicating a “means plus function” relationship unless the word “means” is specifically recited in an element, and are to be interpreted as indicating a “means plus function” relationship where the word “means” is specifically recited in an element. Similarly, the elements of the claims are not to be interpreted as indicating a “step plus function” relationship unless the word “step” is specifically recited in an element, and are to be interpreted as indicating a “step plus function” relationship where the word “step” is specifically recited in an element.

It will be apparent to skilled persons that many changes may be made to the details of the embodiments discussed herein without departing from underlying principles thereof. Thus, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion herein.

1. A pneumatic safety line hose strong enough to substantially equal or exceed strength properties for roofer safety lines in OSHA occupational safety laws, the hose comprising:
an elongated flexible pneumatic hose comprising at least first and second ends and a passageway from the first end to second end for communicating compressed air adequate to drive a pneumatic tool; and
an elongated flexible, safety line combined with and co-extensive with at least a substantial portion of the pneumatic hose to provide a single elongated entity forming the pneumatic safety line hose, the safety line hose configured to hold a worker to a structure.

2. The safety line hose of claim 1 wherein the first end of the elongated flexible pneumatic hose comprises a first adaptor configured to operably connect to a source of compressed air and the second end comprises a second adaptor configured to operably connect to the pneumatic tool.

3. The safety line hose of claim 2 wherein the first adaptor is configured to connect to an air hose carrying air from an air compressor and the second adaptor is configured to connect directly to the pneumatic tool.

4. The safety line hose of claim 1 wherein the safety line hose comprises a safety fastening structure adapted to be releasably fastened to a safety line attachment member.

5. The safety line hose of claim 4 wherein the safety fastening structure is a ring.

6. The safety line hose of claim 4 wherein a releasable fastening member is attached to the safety line, the releasable fastening member adapted to releasably attach to the safety line attachment member.

7. The safety line hose of claim 1 wherein the safety line hose comprises a wear resistant sheath with frictional properties adapted to allow a rope grab to cinch and hold.

8. The safety line hose of claim 1 wherein the elongated safety line substantially envelops the elongated pneumatic hose where the hose and line are co-extensive.

10. The safety line hose of claim 1 wherein the first end comprises a compressor air hose connector that forms a part of a safety fastening structure.

11. The safety line hose of claim 1 wherein the first end comprises a compressor air hose connector that exits from the safety line hose prior to the safety fastening member.

12. The safety line hose of claim 1 wherein the first end comprises a compressor air hose connector that exits from the safety line hose after to the safety fastening member.

13. The safety line hose of claim 1 wherein the safety line hose comprises two rope grabs.

14. The safety line hose of claim 13 wherein at least one of the rope grabs is the safety fastening structure.

15. The safety line hose of claim 1 wherein the safety line hose comprises a retraction device configured to extend the safety line hose in response to pulling and retract it when the pulling ceases.

16. A pneumatic safety line hose system comprising a pneumatic safety line hose of claim 1, wherein the safety line hose is attached to a safety line attachment member.

17. The safety line hose of claim 16 wherein at least one of the safety line hose and the safety line attachment member comprises a retraction device configured to extend the safety line hose in response to pulling and retract it when the pulling ceases.

18. A method of securing a worker to a structure comprising:
anchoring a safety line hose according to any one of claims 1-18 to the structure; and,
attaching the worker to the safety line hose.

19. The method of claim 18 wherein the method further comprises delivering compressed air through the safety line hose to a pneumatic tool.

20. The method of claim 19 wherein the method further comprises driving the pneumatic tool using the compressed air.

21. The method of claim 18 wherein the method further comprises providing a retraction device then extending the safety line hose from the retraction device in response to pulling and retracting it when the pulling ceases.

22. A method of making a safety line hose comprising:
combining into a single elongated entity an elongated flexible pneumatic hose comprising first and second ends and a passageway for communicating compressed air adequate to drive a pneumatic tool from the first end to the second end and an elongated flexible, safety line to provide the pneumatic safety line hose configured to hold a worker to a structure.

23. The method of claim 22 wherein the method further comprises delivering compressed air through the safety line hose to a pneumatic tool.

24. The method of claim 22 wherein the method further comprises combining a hose and line strong enough to substantially equal or exceed strength properties for roofer safety lines in OSHA occupational safety laws.

25. The method of claim 22 wherein the method further comprises configuring the first end of the elongated flexible pneumatic hose to have a first adaptor configured to operably connect to a source of compressed air and configuring the second end to comprise a second adaptor configured to operably connect to the pneumatic tool.

26. The method of claim 25 wherein the first adaptor is configured to connect to an air hose carrying air from an air compressor and the second adaptor is configured to connect directly to the pneumatic tool.

27. The method of claim 22 wherein method further comprises providing a safety fastening structure in the safety line hose, the safety fastening structure adapted to be operably fastened to a safety line attachment member.

28. The method of claim 22 wherein method further comprises attaching a releasable fastening member to the safety line, the releasable fastening member adapted to releasably attach to the safety line attachment member.

29. The method of claim 22 wherein method further comprises configuring the safety line hose to operably accept a rope grab suitable to attach a worker to the safety line hose.

30. The method of claim 22 wherein method further comprises substantially enveloping the elongated pneumatic hose where the hose and line are co-extensive.

31. The method of claim 22 wherein method further comprises attaching two rope grabs to the safety line hose.

32. The method of claim 30 wherein at least one of the rope grabs is the safety fastening structure.

33. The method of claim 22 wherein method further comprises providing a retraction device configured to extend the safety line hose in response to pulling and retract it when the pulling ceases.
